(19) United States
(12) Patent Application Publication
(10) Pub. No.: US 2026/0093468 A1
(43) Pub. Date: Apr. 2, 2026

(54) ARTIFICIAL INTELLIGENCE DRIVEN SYSTEM FOR MANAGING DEPLOYMENT ACTIONS BASED ON SENTIMENT ANALYSIS

(71) Applicant: Intuit Inc., Mountain View, CA (US)

(72) Inventor: Waseem Akram SYED, San Jose, CA (US)

(73) Assignee: Intuit Inc., Mountain View, CA (US)

(21) Appl. No.: 18/901,804

(22) Filed: Sep. 30, 2024

(51) Int. Cl. G06F 8/60; G06F 40/247; G06F 40/30

(52) U.S. Cl. CPC G06F 8/60; G06F 40/247; G06F 40/30

(57) ABSTRACT

Artificial Intelligence driven system for managing deployment actions based on sentiment analysis includes performing operations including obtaining an assigned feature name for an application feature of a target application, selecting, using respective vector encodings of an application feature name that include the assigned feature name, and filtering a collection of feedback using a set of application feature names of an application feature to obtain a filtered set of feedback. The operations further include generating a sentiment request prompt requesting a sentiment score and comprising the filtered set of feedback and the set of application feature names, and processing, by a large language model (LLM), the filtered set of feedback with the set of application feature names to generate the sentiment score for the application feature. The operations further include selecting a recommended action based on the sentiment score and updating the target application according to the recommended action.

### BACKGROUND

Software applications can have millions of application features, from underlying features that control the transmissibility of data, processing features that process data in a particular way, and user interface features that interface with end users. Large scale organizations often have deployment cycles in which hundreds or thousands of updates to existing software applications are released. The updates may add, remove, or update individual application features. The same application feature may be in multiple software applications of the organization and a single software application may have several application features on which updates are performed.

Tracing feedback on updates to software applications has relied on test group rollouts, user interfaces, and natural language processing. In test group rollouts, a limited number of application features of a particular application are provided to the test group. In a user interface, the test group may then be requested to provide textual feedback for a particular application feature or for the overall software application. The user interface may also allow the user to enter a star review. Thus, the user interface links the application feature, the software application, and the feedback. Natural language processing (e.g., that uses positive keywords, negative keywords, or neutral keywords) may be performed on the textual based feedback to determine if the user is using generally positive, negative, or neutral reviews. Based on the feedback and the linkage to the application feature from the user interface, an application developer (i.e., at least one human) may update the application feature and manually release the application feature to more users.

Because of the potential for false data and hallucinations of large language models, as well as the complexity of linking application features to software applications to the feedback, the process is largely manual and often does not correctly identify which application features have the specific feedback.

### SUMMARY

In general, in one aspect, one or more embodiments relate to a method that includes obtaining an assigned feature name for an application feature of a target application, selecting, using respective vector encodings of an application feature name, a set of application feature names including the assigned feature name, and filtering a collection of feedback using a set of application feature names of an application feature to obtain a filtered set of feedback. The method further includes generating a sentiment request prompt requesting a sentiment score and comprising the filtered set of feedback and the set of application feature names, and processing, by a large language model (LLM), the filtered set of feedback with the set of application feature names to generate the sentiment score for the application feature. The method further includes selecting a recommended action based on the sentiment score and updating the target application according to the recommended action.

In general, in one aspect, one or more embodiments relate to a system that includes at least one computer processor, a deployment action handler executing on the at least one computer processor and an LLM. The deployment action handler includes a vector encoding based feedback filter configured to perform first operations that include obtaining an assigned feature name for an application feature of a target application, selecting, using respective vector encodings of an application feature name, a set of application feature names comprising the assigned feature name, and filtering a collection of feedback using a set of application feature names of an application feature to obtain a filtered set of feedback. The deployment action handler further includes a prompt creator configured to perform second operations that includes generating a sentiment request prompt requesting a sentiment score and including the filtered set of feedback and the set of application feature names. The deployment action handler further includes a sentiment interface configured to perform third operations including selecting a recommended action based on the sentiment score and updating the target application according to the recommended action. The LLM is configured to execute on the at least one computer processor to perform fourth operations including processing the filtered set of feedback with the set of application feature names to generate the sentiment score for the application feature.

In general, in one aspect, one or more embodiments relate to a non-transitory computer readable medium including computer readable program code for causing a computer system to perform operations. The operations include obtaining an assigned feature name for an application feature of a target application, selecting, using respective vector encodings of an application feature name, a set of application feature names comprising the assigned feature name, and filtering a collection of feedback using a set of application feature names of an application feature to obtain a filtered set of feedback. The operations further include generating a sentiment request prompt requesting a sentiment score and comprising the filtered set of feedback and the set of application feature names, processing, by an LLM, the filtered set of feedback with the set of application feature names to generate the sentiment score for the application feature, selecting a recommended action based on the sentiment score, and updating the target application according to the recommended action.

Other aspects of one or more embodiments will be apparent from the following description and the appended claims.

### BRIEF DESCRIPTION OF DRAWINGS

FIG. 1 shows a system in accordance with one or more embodiments.

FIG. 2 shows a flowchart for selecting alternative names of features in accordance with one or more embodiments.

FIG. 3 shows a flowchart for performing deployment actions for sentiment analysis in accordance with one or more embodiments.

FIG. 4 shows an example of requesting sentiment analysis in accordance with one or more embodiments.

FIG. 5 shows an example of deployment action definitions in accordance with one or more embodiments.

FIG. 6A and FIG. 6B show a computing system in accordance with one or more embodiments.

Like elements in the various figures are denoted by like reference numerals for consistency.

### DETAILED DESCRIPTION

One or more embodiments are directed to performing sentiment analysis on feedback that links the feedback to the application feature and the software application. Embodiments further provide a technique for updating one or more application features in the software application based on the sentiment analysis of feedback. Generally, feedback is provided in relation to a particular software application. For example, a user may provide the feedback in a particular user interface for the software application or may use a common name of the software application in the feedback. However, the same does not exist for particular application features. Specifically, application features often do not have common names that are known by end users. Thus, users may use their own concocted names or descriptions for particular application features in the feedback. Accordingly, a clear linkage does not exist between the feedback and the application feature to which the feedback applies. Within an organization that develops software, the application feature may have an assigned feature name. The assigned feature name may be a descriptive name of the application feature.

To address linking the application feature to the feedback, one or more embodiments identify vector distances between vector encodings of the assigned feature name and possible alternative names. The feedback is filtered based on the set of application feature names that includes the application feature name and the determined alternative names. Thus, the linkage between the feedback and the application feature may be established. A prompt is generated that includes a sentiment score for the application feature. The filtered feedback is provided to a large language model (LLM) with a request to provide a sentiment score for the application feature. The LLM responds with the sentiment score. Using the sentiment score and the linkage to one or more software applications and particular features in the software application, a recommended action may be determined and used to update the software application. In some cases, as defined by the configuration parameters, the recommended action is automatically performed. For example, the application feature may be updated, an alternative interface may be used, the users having access to the application feature may change, or other changes may be automatically performed without any user interaction. Thus, embodiments link users'feedback to a particular application feature and software application and provide a way to automatically update the software application for the same users or one or more other users.

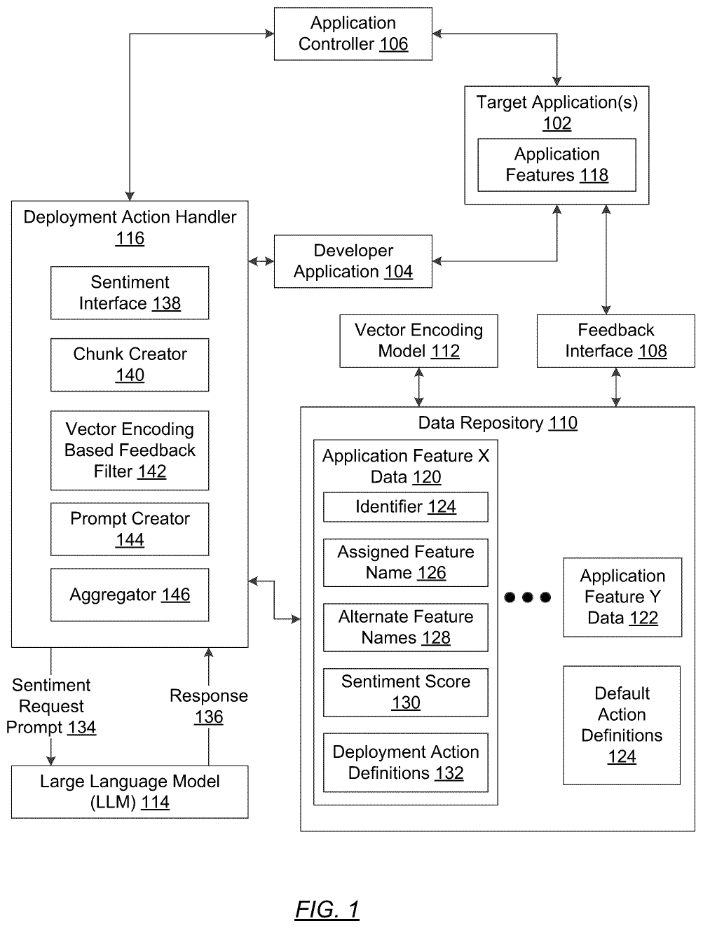

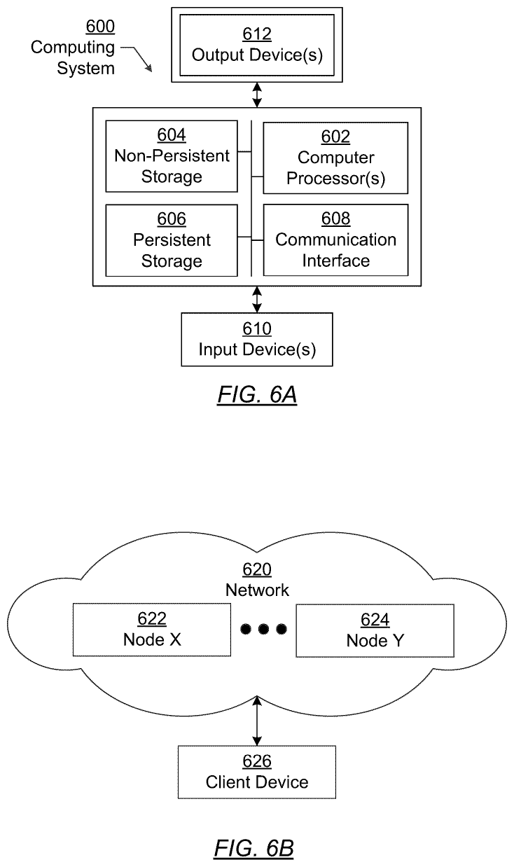

Turning to FIG. 1, FIG. 1 shows a diagram of a system in accordance with one or more embodiments. As shown in FIG. 1, the system may include one or more target applications (102), a developer application (104), an application controller (106), a feedback interface (108), a data repository (110), a vector encoding model (112), a large language model (114), and a deployment action handler (116). The various components of the system may execute on one or more computing systems described below in reference to FIG. 6A and FIG. 6B. For example, the one or more computing systems may be a server computer, a user computing device, or other type of computing system. Each of these components are described below.

In one or more embodiments, the target applications (102) are software applications for which feedback may be received and that may be updated with application features (118). One or more target applications may be large software programs, including data management suites, security programs, financial application suites, and other types of software programs. In some embodiments, the software applications include enterprise applications. For example, tens to hundreds of applications may be deployed by a large software organization.

Each target application includes application features (118). An application feature is an individual component of an application that is deployed as a unit. An application feature may be developed for and deployed in a single target application. An application feature may be deployed in multiple target applications. For example, the code of the application feature may be part of multiple applications or part of a software library linked to multiple applications. Example application features include user interface widgets that trigger a target application to perform an operation, an underlying functionality of a target application, a linkage to a file interface, or other functionality coded in a software application. A target application is updated with an application feature (118) when the application feature is added to the target application or modified in the target application. An application feature may be in an enabled or disabled state in the target application. In an enabled state, the application feature may be used. In the disabled state, the code of the application feature may be present in the target application but may not be functional. The enabled or disabled state may be set by a configuration parameter and defined on a per user or user group basis. By allowing for application features to be in disabled or enabled states, the application feature may be rolled out to sets of test users before being enabled for an entire populus of users.

A developer application (104) is an application for developing or otherwise modifying the target applications (102). For example, the developer application may be an application that is used to create the code of the application or an application that controls the rollout configuration of the target application. A developer application (104) may have an interface for communicating with a developer. A developer is a team or individual user that may create or update the target application or application feature. Although a single developer application is shown, multiple developer applications may exist. For example, each developer application may be responsive for an individual feature or set of features.

An application controller (106) is configured to automatically update a target application (102). Automatic updating is an update performed without user interaction. For example, the application controller (106) may change a configuration of a target application by switching to alternate application features or forms of application features, changing the enabling or disabling of the application on one or more user devices, or performing another action that modifies the target application with respect to one or more application features. Multiple application controllers (106) may exist in various arrangements with target applications (102) and application features (118).

A feedback interface (108) is an application programming interface or user interface for obtaining a collection of feedback from one or more users. In general, feedback is information specifying a reaction to the application. A single item of feedback from a user may be for one or more target applications and one or more application features within the one or more target applications. The feedback may or may not include the assigned name of the application feature. Feedback may include a scaled ranked review (e.g., a star review), textual freeform feedback, form-based feedback, and other types of feedback. The feedback interface (108) may be a link to a third-party software, such as a third-party website by which users may submit user reviews. The feedback interface (108) may be an interface within the target application or by an organization creating or deploying the target application. Multiple feedback interfaces (108) may exist, each corresponding to a different type of feedback or for a third party.

The data repository (110) is a type of storage unit or device (e.g., a file system, database, data structure, or any other storage mechanism) for storing data. The data repository (110) may include multiple different, potentially heterogeneous, storage units and/or devices. The data repository (110) is configured to store application feature data (e.g., application feature X data (120), application feature Y data (122)), and default action definitions (124). For simplicity of the figure, only application feature X data (120) is shown in expanded form. The other application feature data may be the same as shown in the expanded form.

Application feature data (e.g., application feature X data (120), application feature Y data (122)) is data stored for a particular application feature. The application feature data may also be stored on a per target application basis. The application feature data may include an identifier (124), an assigned feature name (126), one or more alternative feature names (128), a sentiment score (130), and one or more deployment action definitions (132).

The identifier (124) is a unique identifier of the application feature. For example, the identifier (124) may be an alphanumeric identifier of the application feature. The assigned feature name (126) is a descriptive name of the application feature. The assigned feature name (126) may be the name of the application feature as assigned by a developer or other individual associated with an organization. The assigned feature name (126) identifies the application features amongst the set of application features in a release.

The application feature data may also include one or more alternative feature names (128). Alternative feature names (128) are other possible names for identifying the application feature. The alternative feature names (128) may be names that are semantically similar to the assigned feature name. For example, the alternative feature names may be synonyms with the assigned feature name or a description of the application feature.

The sentiment score (130) is a score assigned to the application feature. The sentiment score (130) is a score determined from the feedback. The sentiment score may be a numeric score, such as a score defined on a scale. As another example, the sentiment score (130) may be an alphabetic score.

The deployment action definitions (132) are definitions that relate various types of recommended actions determined from sentiment scores to corresponding recommended actions. In some embodiments, at least three types of recommended actions exist. A first category of the sentiment score is a destructive action. A destructive action reduces the release of the application feature. For example, the destructive action may replace the application feature, reduce a number of users having the application feature, or remove the application feature, or another action that reduces the deployment of the application feature. A second recommended action type is a steady state type. In the steady state type, the recommended action is not to make changes to the deployment. The steady state may be to keep with the current deployment or keep with the current plan of the deployment. Keeping with the current plan may be to increase users that can view the application feature according to a predefined plan. A third type is a constructive action type. The constructive action type is a type that increases the deployment. For example, the constructive action may ramp up the number of users that have access to the application feature. As another example, the constructive action type may add further predefined augmentations to the application feature (e.g., add additional features to the application feature).

The deployment action definitions (132) may also include a definition of the recommended action. The definition may be code, a configuration parameter, or other type of definition of the recommended action. The recommended action and application feature may be associated with an automated action flag. The automated action flag is a binary flag that identifies whether to perform the recommended action without any user input, including developer user input.

The default action definitions (124) are deployment action definitions that are defined by default. The default action definitions (124) may be default for all or at least a subset of target applications or application features.

Continuing with FIG. 1, the vector encoding model (112) is a machine learning model that is configured to generate a vector encoding from the assigned feature name (126) and from collections of one or more possible feature names. A vector encoding is a numeric encoding whereby distance between vector encodings is indicative of the degree to which the application features are semantically similar. In one or more embodiments, the vector encoding model is an OpenAI model. Other vector encoding models may be used without departing from the scope of the invention.

The system also includes a large language model (114). A large language model (114) is a computational model capable of language generation or other natural language processing tasks. The language model is an artificial neural network. The language model may be a decoder side of transformer-based architecture. Specific training of the large language model (114) may be performed dynamically as part of the prompt to the large language model (114) or prior to transmitting the prompt to the large language model (114). For example, the large language model is a general-purpose model configured to receive a sentiment request prompt (134) with specific instructions and generate a response (136) to the sentiment request prompt (134). The specific instructions provide for further training of the large language model to provide the sentiment request prompt (134). In other embodiments, the large language model (114) is a specifically trained model. If a specifically trained model, the sentiment request prompt may just include feedback or more generalized instructions.

In one or more embodiments, the sentiment request prompt (134) includes feedback, one or more application feature names, one or more alternate feature names, and an instruction. The instruction requests that the large language model (114) assign a sentiment score to the feedback. The instructions may further request that the large language model (114) provide a summary of the feedback, a reason for the sentiment score, and a source of the feedback that caused the sentiment score. The instructions may further include few-shot examples. Few-shot examples are training data in which example feedback is matched to example output.

Continuing with FIG. 1, the deployment action handler (116) is configured to receive the sentiment scores and trigger a deployment action based on the sentiment score. The deployment action handler (116) includes a sentiment interface (138), chunk creator (140), a vector encoding based feedback filter (142), a prompt creator (144), and an aggregator (146). Each of these components are described below.

The sentiment interface (138) may be an application programming interface (API) or graphical user interface (GUI) that is configured to present the results of the sentiment analysis. The sentiment interface (138) may be configured to trigger an update of the target application based on the sentiment analysis.

The chunk creator (140) is configured to divide the feedback into chunks. Chunks are contiguous portions of the feedback, that is potentially overlapping other chunks. For example, a chunk may be a particular item of feedback, a portion of one or more items of feedback. In one or more embodiments, the chunk size may be set based on limits of the large language model (114). For example, the chunk size may be 300 terms.

The vector encoding based feedback filter (142) is configured to filter the feedback using the vector encoding model. For example, the vector encoding based feedback filter is configured to determine alternate feature names for the assigned feature name based on corresponding vector encodings. The vector encoding based feedback filter (142) is further configured to select feedback relevant to a particular application feature using the assigned feature name and alternative feature name(s).

The prompt creator (144) is configured to create the sentiment request prompt (144) using the selected feedback to obtain a sentiment score. The prompt creator (144) may have a predefined template and few-shot examples to create the prompt.

The aggregator (146) is configured to aggregate the responses on a per application feature basis to determine an aggregator feature score. For example, the aggregator (146) may separate out a single response that includes multiple application features in the same prompt. As another example, feedback may be processed in batches. The batches may correspond to different time periods in which the feedback is obtained. The aggregator is configured to aggregate the feedback across the various responses.

While FIG. 1 shows a configuration of components, other configurations may be used without departing from the scope of one or more embodiments. For example, various components may be combined to create a single component. As another example, the functionality performed by a single component may be performed by two or more components.

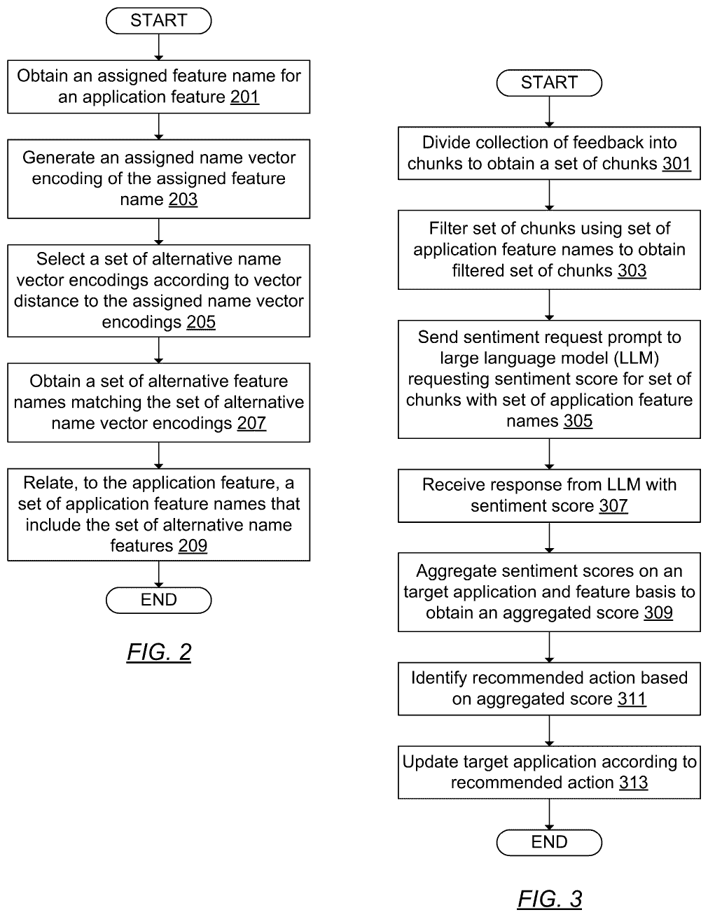

FIG. 2 and FIG. 3 shows flowcharts in accordance with one or more embodiments of the invention. The flowcharts of FIG. 2 and FIG. 3 may be implemented using the system of FIG. 1 and one or more of the steps may be performed on or received at one or more computer processors. While the various blocks are presented and described sequentially, at least some of the steps may be executed in different orders, may be combined or omitted, and at least some of the blocks may be executed in parallel. Furthermore, the blocks may be performed actively or passively.

Turning to FIG. 2, FIG. 2 shows a flowchart for identifying alternative feature names. Features of the application may not have publicly common names. Namely, when a new feature is created, the feature may have the assigned feature name that is assigned and used by the vendor. The vendor may or may not publicize the assigned feature name. Regardless of the publication of the assigned feature name, end users may or may not use the assigned feature name when referring to the feature. For example, a feature of enabling “inserting figures” into a document of one or more target applications may be referred to as “drawing feature”, “inserting an image”, “adding diagram”, or other words. The various ways in which a user may not refer to an application feature may not be known prior. Moreover, the same application feature may be in multiple target applications. Thus, linking the users'feedback to the corresponding application feature may not be word mapping. FIG. 2 shows a flowchart for identifying alternative names.

In Block 201, an assigned feature name for an application feature is obtained. The assigned feature name may be obtained from release documents for the application feature. As an example, the assigned feature name may be obtained from an internal database.

In Block 203, an assigned name vector encoding of the assigned feature name is generated. The assigned feature name is provided as input to a trained vector embedding model. The vector embedding model may transform each word in the assigned feature name to a corresponding vector embedding. The vector embedding model may be a term-frequency inverse document frequency (TF-IDF) model. The vector embedding model relates individual terms to vectors whereby the distance between vectors is the degree to which the words are semantically similar. Thus, semantically similar words are close in the vector space whereas semantically dissimilar words have greater difference in the vector space. An encoder model then processes the vectors to generate a vector encoding. The encoder model may be the encoding portion of a transformer-based architecture that is configured to combine the vector embeddings to capture the semantic meaning of the assigned feature name. Thus, individual terms may have a meaning that is captured in the vector embedding and the collection of terms in the vector encoding model has a meaning that is captured in the vector encoding model.

The TF-IDF model may be a general-purpose TF-IDF model. The encoder model may be a specifically trained encoder model. For example, the encoder model may be trained for a specific domain of the vendor or of application features.

In Block 205, a set of alternative name vector encodings is selected according to vector distance to the assigned name vector encodings. For example, a dictionary of possible feature names or a collection of synonyms of terms may be used to generate the possible alternative names. The possible alternative names are each encoded to generate the alternative name vector encodings. The alternative name vector encodings may be generated in a same or similar way as generating the assigned name vector encoding in Block 203. The alternative name vector encodings may be pre-generated, saved in an index related to the corresponding alternative feature name.

Vector distances are calculated between the assigned feature name and the possible alternative name vector encodings. The vector distance may be cosine distance, for example. Other vector distances may be used without departing from the scope of the invention. The alternative name vector encodings that are within a threshold distance are selected as part of the set of alternative name vector encodings.

In Block 207, a set of alternative feature names matching the set of alternative name vector encodings is obtained. As discussed above, each alternative name vector encoding may be related in an index to the corresponding alternative feature name. Thus, the set of alternative feature names are obtained from the index.

In Block 209, a set of application feature names that include the set of alternative name features are related to the application feature. The application feature names include the assigned feature name and the alternative feature name. The application feature names are related to the application feature.

Using the various application feature names, feedback associated with the application feature is processed to perform a sentiment analysis. FIG. 3 shows a flowchart for performing sentiment analysis using the various application feature names.

In Block 301, a collection of feedback is divided into chunks to obtain a set of chunks. Feedback may be obtained from interfaces of the application and vendor, third-party websites, and other sources. The feedback is divided into chunks, which may be overlapping. In one or more embodiments, items of feedback are kept in a single chunk to the extent possible. If a feedback item includes more than a maximum chunk size, then the item is divided into multiple chunks.

In Block 303, the set of chunks is filtered using the set of application feature names to obtain a filtered set of chunks. Each chunk in the set of chunks is parsed to determine whether the chunk includes any of the application feature names. A chunk includes an application feature name when terms in the chunk is at least substantially similar to the application feature name. For example, the terms in the chunk may be normalized and stop words removed prior to the comparison. Similarly, the comparison may account for spelling errors, extraneous terms, and other changes.

In Block 305, a sentiment request prompt is sent to the large language model (LLM) requesting a sentiment score for the set of chunks with the set of application feature names. A sentiment request prompt is generated by adding a predefined instruction requesting that the LLM provide a sentiment score for the set of chunks on the set of application feature names. Thus, the sentiment request prompt is generated by appending the predefined instruction to the set of chunks and the set of application feature names according to a predefined template. Few-shot examples may be added to the sentiment request prompt. The few-shot examples may be selected based on a comparison with the application feature name. Further, a single sentiment request prompt may request a sentiment analysis of multiple application features, and thus, may request that the LLM partition out the sentiment analysis according to the application features. The sentiment request prompt is transmitted according to the API of the LLM. In some embodiments, separate sentiment request prompts are generated and sent for different subsets of the set of chunks. In some embodiments, the set of chunks is specific to a particular target application and may include one or more application features. In other embodiments, each chunk is related to a corresponding target application (e.g., using a target application identifier) and one or more application features. Different configurations may be used without departing from the scope of the claims.

In Block 307, a response from the LLM is received with the sentiment score. The response may include the sentiment score(s) for one or more application features partitioned by application feature and target application. The response may include an identifier of the request and is associated with the request.

In Block 309, the sentiment scores are aggregated on a target application and application feature basis. As discussed above, feedback may be received over time. Thus, aggregation combines the feedback over the different time periods. The aggregation may be to generate a sentiment score for each pair of application feature and target application. Further, a general sentiment score for an application feature regardless of the target application may be generated. The aggregation may be a weighted average, a sliding window average, or other aggregation technique.

In Block 311, a recommended action is identified based on the aggregated score. The aggregated score is compared to one or more thresholds to determine the recommended action. In particular, the thresholds may each correspond to a recommended action type. Each recommended action type is associated with a corresponding recommended action for the application feature or application feature and target application. By performing a table lookup, the recommended action may be identified.

In Block 313, the target application is updated according to the recommended action. One or more target applications incorporating the application feature may be updated. Updating the target application may include determining whether the automated action flag is set for the recommended action. If the automated action flag is set, then updating the target application includes sending a request to the application controller for the target application. The application controller configures the deployment of the application feature of the target application. For example, the application controller may change a configuration of the target application for one or more end users to add or remove the application feature. As another example, the application controller may cause the application feature to be replaced. For example, a different interface may be displayed based on the sentiment score. The different interface may include be a removal of the application feature with an alternative interface, a next iteration of the application feature that includes additional or reduced functionality.

In some cases, if the automated action flag is set, a notification is transmitted to the developer application. The notification may include one or more target applications, the application feature, the sentiment score, the reasons for the sentiment score, and an example feedback that caused the sentiment score. The developer may then approve or disapprove of performing the recommended action. If the developer approves of the recommended action, the application controller may update the target application based on the recommended action as described above. If the developer disapproves of the recommended action, the developer may optionally modify which action, if any, is performed based on the sentiment score.

Whether the application feature is updated across the target applications or just for a particular target application may be based on the general sentiment score. For example, if sentiment score is low across most target applications and medium rated on one or more other target applications, the application feature may be removed from each of the target applications. As another example, if the application feature has a general sentiment score that is high, then the application feature may be deployed to more target applications.

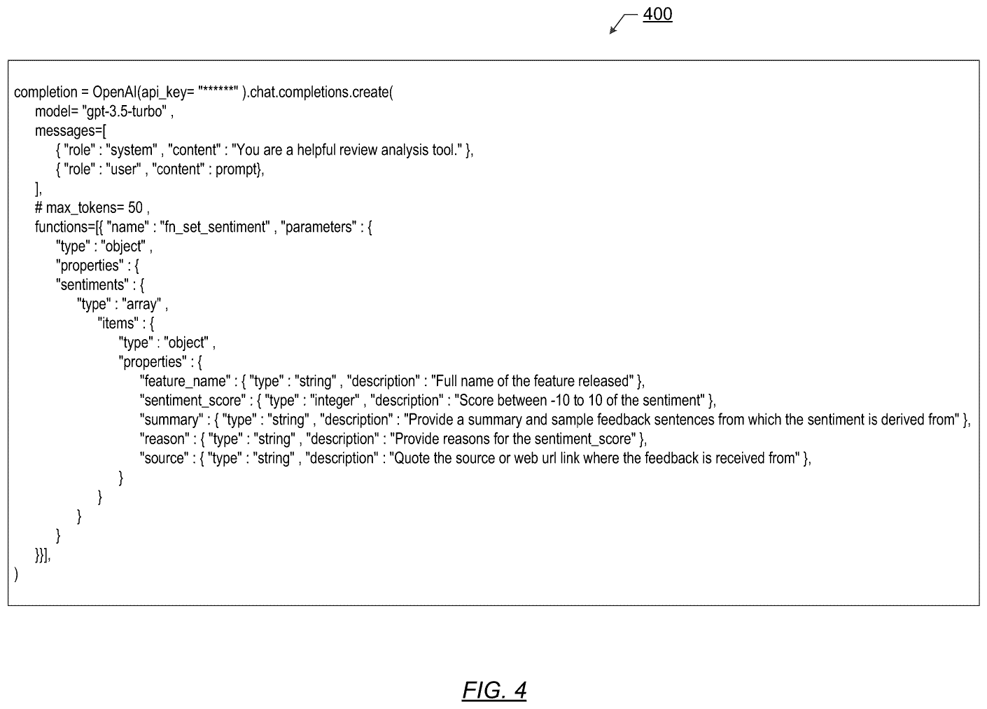

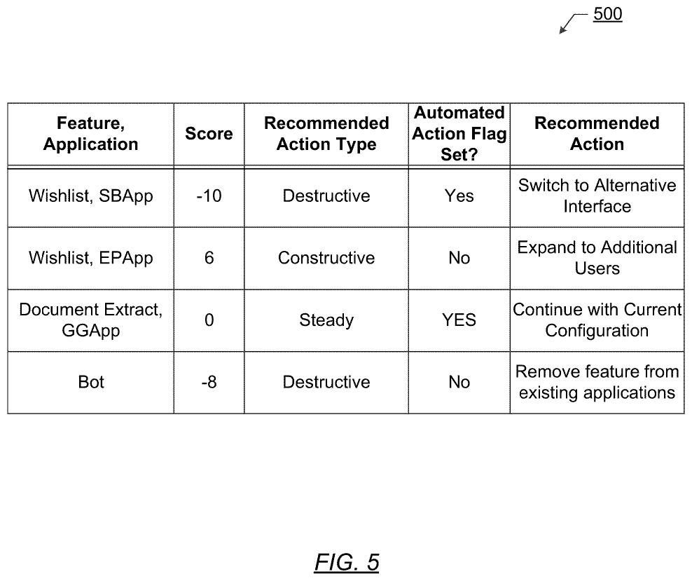

FIG. 4 and FIG. 5 show examples in accordance with one or more embodiments. In the example, consider the problem of ensuring that a scalable roll out strategy is performed in large scale organizations when multiple application features are released during a cycle. One or more embodiments aim to use the sentiment analysis from the various feedback channels to orchestrate a scalable roll out strategy for deployment of applications.

For example, consider the scenario in which multiple application features are released in a cycle during tax peak or holidays. The feedback is monitored for the application features and stored in a data lake. As the feedback is stored in a data lake, filters are applied to the feedback based on a combination of manual and LLM based techniques. The manual filtering process may include adding the synonymic names for the application feature as filters. For example, if twenty application features are released in production and the twenty application features include “Wishlist”, “Document Extract”, “File taxes with bot”, etc., any match to “Wishlist” or synonyms of “Wishlist” like Favorites, Preferred, etc. are flagged. The flagged feedback is sent to the LLM.

The automated process to identify the alternative application feature names includes generating the vector embeddings for the various application features and comparing the closest matches in the vector database.

The LLM performs a sentiment analysis and determines if the feedback is positive or negative and provides a score. FIG. 4 shows an example of a sentiment request prompt. As shown in FIG. 4, the sentiment request prompt includes a statement that the LLM is a helpful review analysis tool, and a request to the LLM to provide specific information regarding the feature name, the sentiment score, the summary, the reason for the sentiment score, and the source.

The LLM processes the chunks of feedback and provides a response. The response is aggregated into a table, such as the table (500) shown in FIG. 5. As shown in the table of FIG. 5, different actions may be performed including steady actions, destructive actions, and constructive actions. For example, as shown in the table, the constructive action for “Wishlist” is to enable the Wishlist feature to additional users, such as using A/B Test. The constructive action may be performed for Wishlist and the EPApp target application based on the sentiment score of six. The automated action flag is not set, thereby requiring a notification to a developer to approve of the action.

The destructive action for “Wishlist” is to switch to an alternative interface that does not include the Wishlist feature. The destructive action is performed automatically based on a score of negative ten and the automated action flag being set. Thus, using a Remote Config flag or Switch users to Bucket A (previous state) is performed by the application controller.

A steady state action may be to continue with the current configuration, which may be automated. The current configuration may be to ramp up the feature by 10% according to a predefined plan. The steady state action may be automatically performed for a document extract feature and the GGApp target application based on a sentiment score of zero.

In some cases, the feature is completely removed from the existing applications based on a general sentiment score. For example, the bot feature may not be well received, and thus, removed from all target applications as part of a destructive action. Because the destructive action performs a larger change, the automated action flag is not set, and the developer user is notified. The developer user may review the feedback and the reasons for the score to determine to make the change.

As shown, one or more embodiments provide a technique to perform sentiment analysis on application features. Further, one or more embodiments enable automatic or approved updates to a target application. By linking feedback to application features and target applications and then performing the sentiment analysis, a more robust deployment of application features may be performed.

One or more embodiments may be implemented on a computing system specifically designed to achieve an improved technological result. When implemented in a computing system, the features and elements of the disclosure provide a significant technological advancement over computing systems that do not implement the features and elements of the disclosure. Any combination of mobile, desktop, server, router, switch, embedded device, or other types of hardware may be improved by including the features and elements described in the disclosure.

For example, as shown in FIG. 6A, the computing system (600) may include one or more computer processor(s) (602), non-persistent storage device(s) (604), persistent storage device(s) (606), a communication interface (608) (e.g., Bluetooth interface, infrared interface, network interface, optical interface, etc.), and numerous other elements and functionalities that implement the features and elements of the disclosure. The computer processor(s) (602) may be an integrated circuit for processing instructions. The computer processor(s) (602) may be one or more cores, or micro-cores, of a processor. The computer processor(s) (602) includes one or more processors. The computer processor(s) (602) may include a central processing unit (CPU), a graphics processing unit (GPU), a tensor processing unit (TPU), combinations thereof, etc.

The input device(s) (610) may include a touchscreen, keyboard, mouse, microphone, touchpad, electronic pen, or any other type of input device. The input device(s) (610) may receive inputs from a user that are responsive to data and messages presented by the output device(s) (612). The inputs may include text input, audio input, video input, etc., which may be processed and transmitted by the computing system (600) in accordance with one or more embodiments. The communication interface (608) may include an integrated circuit for connecting the computing system (600) to a network (not shown) (e.g., a local area network (LAN), a wide area network (WAN) such as the Internet, mobile network, or any other type of network) or to another device, such as another computing device, and combinations thereof.

Further, the output device(s) (612) may include a display device, a printer, external storage, or any other output device. One or more of the output device(s) (612) may be the same or different from the input device(s) (610). The input device(s) (610) and output device(s) (612) may be locally or remotely connected to the computer processor(s) (602). Many different types of computing systems exist, and the aforementioned input device(s) (610) and output device(s) (612) may take other forms. The output device(s) (612) may display data and messages that are transmitted and received by the computing system (600). The data and messages may include text, audio, video, etc., and include the data and messages described above in the other figures of the disclosure.

Software instructions in the form of computer readable program code to perform embodiments may be stored, in whole or in part, temporarily or permanently, on a non-transitory computer readable medium such as a solid state drive (SSD), compact disk (CD), digital video disk (DVD), storage device, a diskette, a tape, flash memory, physical memory, or any other computer readable storage medium. Specifically, the software instructions may correspond to computer readable program code that, when executed by the computer processor(s) (602), is configured to perform one or more embodiments, which may include transmitting, receiving, presenting, and displaying data and messages described in the other figures of the disclosure.

The computing system (600) in FIG. 6A may be connected to, or be a part of, a network. For example, as shown in FIG. 6B, the network (620) may include multiple nodes (e.g., node X (622) and node Y (624), as well as extant intervening nodes between node X (622) and node Y (624)). Each node may correspond to a computing system, such as the computing system shown in FIG. 6A, or a group of nodes combined may correspond to the computing system shown in FIG. 6A. By way of an example, embodiments may be implemented on a node of a distributed system that is connected to other nodes. By way of another example, embodiments may be implemented on a distributed computing system having multiple nodes, where each portion may be located on a different node within the distributed computing system. Further, one or more elements of the aforementioned computing system (600) may be located at a remote location and connected to the other elements over a network.

The nodes (e.g., node X (622) and node Y (624)) in the network (620) may be configured to provide services for a client device (626). The services may include receiving requests and transmitting responses to the client device (626). For example, the nodes may be part of a cloud computing system. The client device (626) may be a computing system, such as the computing system shown in FIG. 6A. Further, the client device (626) may include or perform all or a portion of one or more embodiments.

The computing system of FIG. 6A may include functionality to present data (including raw data, processed data, and combinations thereof) such as results of comparisons and other processing. For example, presenting data may be accomplished through various presenting methods. Specifically, data may be presented by being displayed in a user interface, transmitted to a different computing system, and stored. The user interface may include a graphical user interface (GUI) that displays information on a display device. The GUI may include various GUI widgets that organize what data is shown, as well as how data is presented to a user. Furthermore, the GUI may present data directly to the user, e.g., data presented as actual data values through text, or rendered by the computing device into a visual representation of the data, such as through visualizing a data model.

As used herein, the term “connected to”contemplates multiple meanings. A connection may be direct or indirect (e.g., through another component or network). A connection may be wired or wireless. A connection may be a temporary, permanent, or a semi-permanent communication channel between two entities.

The various descriptions of the figures may be combined and may include, or be included within, the features described in the other figures of the application. The various elements, systems, components, and steps shown in the figures may be omitted, repeated, combined, or altered as shown in the figures. Accordingly, the scope of the present disclosure should not be considered limited to the specific arrangements shown in the figures.

In the application, ordinal numbers (e.g., first, second, third, etc.) may be used as an adjective for an element (i.e., any noun in the application). The use of ordinal numbers is not to imply or create any particular ordering of the elements, nor to limit any element to being only a single element unless expressly disclosed, such as by the use of the terms “before”, “after”, “single”, and other such terminology. Rather, ordinal numbers distinguish between the elements. By way of an example, a first element is distinct from a second element, and the first element may encompass more than one element and succeed (or precede) the second element in an ordering of elements.

Further, unless expressly stated otherwise, the conjunction “or” is an inclusive “or” and, as such, automatically includes the conjunction “and,” unless expressly stated otherwise. Further, items joined by the conjunction “or” may include any combination of the items with any number of each item, unless expressly stated otherwise.

In the above description, numerous specific details are set forth in order to provide a more thorough understanding of the disclosure. However, it will be apparent to one of ordinary skill in the art that the technology may be practiced without these specific details. In other instances, well-known features have not been described in detail to avoid unnecessarily complicating the description. Further, other embodiments not explicitly described above can be devised which do not depart from the scope of the claims as disclosed herein. Accordingly, the scope should be limited only by the attached claims.

What is claimed is:

1. A method comprising:
obtaining an assigned feature name for an application feature of a target application;
selecting, using respective vector encodings of an application feature name, a set of application feature names comprising the assigned feature name;
filtering a collection of feedback using a set of application feature names of an application feature to obtain a filtered set of feedback;
generating a sentiment request prompt requesting a sentiment score and comprising the filtered set of feedback and the set of application feature names;
processing, by a large language model (LLM), the filtered set of feedback with the set of application feature names to generate the sentiment score for the application feature;
selecting a recommended action based on the sentiment score; and
updating the target application according to the recommended action.

2. The method of claim 1, wherein updating the target application comprises:
automatically switching, by an application controller directly responsive to selecting the recommended action and the sentiment score, an interface of the application comprising the application feature to an alternative interface omitting the application feature.

3. The method of claim 1, wherein updating the target application comprises:
expanding a number of users having the application feature enabled when the sentiment score satisfies a constructive threshold; and
disabling the application feature on at least a portion of users when the sentiment score satisfies a destructive threshold.

4. The method of claim 3, further comprising:
detecting, responsive to the sentiment score satisfying a destructive threshold, that the automated action flag is not set;
transmitting an alert responsive to the automated action flag not being set;
receiving an approval to disable the application feature from a user interface; and
disabling the application feature responsive to the approval.

5. The method of claim 3, further comprising:
detecting, responsive to the sentiment score satisfying a constructive threshold, that the automated action flag is set,
wherein the number of users is expanded without further input based on the sentiment score satisfying the constructive threshold and the automated action flag being set.

6. The method of claim 1, further comprising:
generating a plurality of chunks from the collection of feedback to obtain a set of chunks, wherein filtering the collection of feedback is on the set of chunks to obtain a filtered set of chucks,
wherein an individual sentiment response prompt is sent for each chunk of the plurality of chunks to obtain a plurality of sentiment scores comprising the sentiment score; and
aggregating the plurality of sentiment scores to obtain an aggregated score, wherein updating the target application is performed on the aggregated score.

7. The method of claim 1, further comprising:
generating, by a vector encoding model, an assigned name vector encoding of the assigned feature name;
selecting a set of alternative name vector encodings according to vector distance to the assigned name vector encoding;
obtaining a set of alternative feature names matching the set of alternative name vector encodings; and
relating, to the application feature, the set of application feature names that include the set of alternative name features.

8. The method of claim 1, wherein the application feature is comprised in a plurality of target applications comprising the target application, wherein the sentiment response prompt further comprises a list of the plurality of target applications and requests the sentiment score on a per target application basis, and wherein the method further comprises:
receiving a plurality of sentiment scores comprising the sentiment score, each sentiment score having a corresponding target application of the plurality of target applications;
for each sentiment score of the plurality of sentiment scores, individually performing an action respective to the application feature for the corresponding target application.

9. The method of claim 1, further comprising:
deploying a plurality of applications with a plurality of application features in a many to many correspondence;
generating at least one sentiment response prompt listing a plurality of pairs comprising a specified application feature of the plurality of application features and a specified target application of the plurality of target applications, the specified target application comprising the specified application feature;
receiving a plurality of sentiment scores comprising the sentiment score, each sentiment score corresponding to a pair of the plurality of pairs;
for each sentiment score of the plurality of sentiment scores, individually performing an action respective to the specified application feature in the specified target application.

10. A system comprising:
at least one computer processor;
a deployment action handler executing on the at least one computer processor comprising:
a vector encoding based feedback filter configured to perform first operations comprising:
obtaining an assigned feature name for an application feature of a target application,
selecting, using respective vector encodings of an application feature name, a set of application feature names comprising the assigned feature name, and
filtering a collection of feedback using a set of application feature names of an application feature to obtain a filtered set of feedback,
a prompt creator configured to perform second operations comprising:
generating a sentiment request prompt requesting a sentiment score and comprising the filtered set of feedback and the set of application feature names, and
a sentiment interface configured to perform third operations comprising selecting a recommended action based on the sentiment score, and updating the target application according to the recommended action; and
a large language model (LLM) configured to execute on the at least one computer processor to perform fourth operations comprising processing the filtered set of feedback with the set of application feature names to generate the sentiment score for the application feature.

11. The system of claim 10, further comprising:
an application controller configured to perform fifth operations comprising:
automatically switching, directly responsive to selecting the recommended action and the sentiment score, an interface of the application comprising the application feature to an alternative interface omitting the application feature.

12. The system of claim 10, further comprising:
an application controller configured to perform fifth operations comprising:
expanding a number of users having the application feature enabled when the sentiment score satisfies a constructive threshold, and
disabling the application feature on at least a portion of users when the sentiment score satisfies a destructive threshold.

13. The system of claim 12, wherein the third operations further comprise:
detecting, responsive to the sentiment score satisfying a destructive threshold, that the automated action flag is not set,
transmitting an alert responsive to the automated action flag not being set to a developer application,
receiving an approval to disable the application feature from a user interface, and
disabling the application feature responsive to the approval.

14. The system of claim 12, wherein the third operations further comprise:
detecting, responsive to the sentiment score satisfying a constructive threshold, that the automated action flag is set, wherein the number of users is expanded without further input based on the
sentiment score satisfying the constructive threshold and the automated action flag being set.

15. The system of claim 10, wherein the deployment action handler further comprises:
a chunk creator configured to generate a plurality of chunks from the collection of feedback to obtain a set of chunks, wherein filtering the collection of feedback is on the set of chunks to obtain a filtered set of chucks,
wherein an individual sentiment response prompt is sent for each chunk of the plurality of chunks.

16. The system of claim 10, further comprising:
a vector encoding model configured to perform fifth operations comprising:
generating, by a vector encoding model, an assigned name vector encoding of the assigned feature name,
wherein the first operations further comprise:
select a set of alternative name vector encodings according to vector distance to the assigned name vector encoding,
obtain a set of alternative feature names matching the set of alternative name vector encodings, and
relate, to the application feature, the set of application feature names that include the set of alternative name features.

17. The system of claim 10, wherein the application feature is comprised in a plurality of target applications comprising the target application, wherein the sentiment response prompt further comprises a list of the plurality of target applications and requests the sentiment score on a per target application basis, and wherein the deployment action handler is further configured to perform fifth operations comprising:
receiving a plurality of sentiment scores comprising the sentiment score, each sentiment score having a corresponding target application of the plurality of target applications, and
for each sentiment score of the plurality of sentiment scores, individually performing an action respective to the application feature for the corresponding target application.

18. The system of claim 10, wherein the deployment action handler is further configured to perform fifth operations comprising:
deploying a plurality of applications with a plurality of application features in a many to many correspondence;
generating at least one sentiment response prompt listing a plurality of pairs comprising a specified application feature of the plurality of application features and a specified target application of the plurality of target applications, the specified target application comprising the specified application feature;
receiving a plurality of sentiment scores comprising the sentiment score, each sentiment score corresponding to a pair of the plurality of pairs;
for each sentiment score of the plurality of sentiment scores, individually performing an action respective to the specified application feature in the specified target application.

19. A non-transitory computer readable medium comprising computer readable program code for causing a computer system to perform operations comprising:
obtaining an assigned feature name for an application feature of a target application;
selecting, using respective vector encodings of an application feature name, a set of application feature names comprising the assigned feature name;
filtering a collection of feedback using a set of application feature names of an application feature to obtain a filtered set of feedback;
generating a sentiment request prompt requesting a sentiment score and comprising the filtered set of feedback and the set of application feature names;
processing, by a large language model (LLM), the filtered set of feedback with the set of application feature names to generate the sentiment score for the application feature;
selecting a recommended action based on the sentiment score; and
updating the target application according to the recommended action.

20. The non-transitory computer readable medium of claim 19, wherein updating the target application comprises:
automatically switching, by an application controller directly responsive to selecting the recommended action and the sentiment score, an interface of the application comprising the application feature to an alternative interface omitting the application feature.
